(19) United States
(12) Patent Application Publication
(10) Pub. No.: US 2025/0047399 A1
(43) Pub. Date: Feb. 6, 2025

(54) AI MONITORING DEVICE AND METHOD

(71) Applicant: FUJITSU LIMITED, Kawasaki-shi (JP)

(72) Inventors: Xin WANG, Beijing (CN); Gang SUN, Beijing (CN); Qun ZHANG, Beijing (CN); Yujia SHAN, Beijing (CN); Meiyi JIA, Beijing (CN)

(73) Assignee: FUJITSU LIMITED, Kawasaki-shi (JP)

(21) Appl. No.: 18/926,868

(22) Filed: Oct. 25, 2024

Related U.S. Application Data
(63) Continuation of application No. PCT/CN2022/090505, filed on Apr. 29, 2022.

(51) Int. Cl. H04B 17/391; H04B 7/06; H04L 1/1812

(52) U.S. Cl. CPC H04B 17/391; H04B 7/0626; H04L 1/1812

(57) ABSTRACT

An AI monitoring device includes: a receiver configured to receive a signal or information transmitted by a terminal equipment; and processor circuitry configured to perform monitoring or performance evaluation on an AI/ML model in a network device and/or the terminal equipment according to the signal or information.

### CROSS-REFERENCE TO RELATED APPLICATION

This application is a continuation application of International Application PCT/CN2022/090505 filed on Apr. 29, 2022, and designated the U.S., the entire contents of which are incorporated herein by reference.

### TECHNICAL FIELD

Embodiments of the present disclosure relate to the technical field of communication.

### BACKGROUND

As low-frequency band spectrum resources become scarce, a millimeter-wave frequency band is capable of providing a greater bandwidth and becomes an important frequency band for a 5G New Radio (NR) system. Millimeter wave has different propagation characteristics from traditional low frequency bands due to its shorter wavelength, such as a higher propagation loss, poor reflection and diffraction performance, etc. Therefore, a larger-scale array of antennas will be usually used to form a beamforming with a greater gain, which overcomes propagation losses and ensures system coverage.

With development of Artificial Intelligence (AI) and Machine Learning (ML) technologies, applying the AI/ML technologies to radio communication becomes a current technical direction, so as to solve the difficulties of traditional methods. Applying AI/ML models in radio communication systems, particularly in transmission of air interfaces, is a new technology in 5G-Advanced and 6G stages.

For example, in terms of reporting Channel State Information (CSI), the CSI is encoded/compressed using an AI encoder at a terminal equipment side, and the CSI is decoded/de-compressed using the AI decoder at a network device side, which may reduce feedback overhead. For another example, in terms of Beam Management, spatially optimal beam pairs are predicted by using AI/ML models according to a result of a small number of beam measurements, which may reduce a load and delay of a system.

It should be noted that the above introduction to the technical background is just to facilitate a clear and complete description of the technical solutions of the present disclosure, and is elaborated to facilitate the understanding of persons skilled in the art. It cannot be considered that said technical solutions are known by persons skilled in the art just because these solutions are elaborated in the Background of the present disclosure.

### SUMMARY

However, the inventor finds that as AI/ML models trained according to data sets, how to adapt to demands for various wireless applications and how to cope with the ever-changing mobile communication environments bring great challenges to AI/ML schemes themselves. For rich wireless communication scenarios, such as suburbs, urban areas, indoors, factories, mines, etc., it is difficult for off-line trained AI/ML models to ensure to keep consistent performance in various circumstances. Therefore, it is necessary to monitor the performance of AI/ML model running and stop using an AI/ML model when necessary.

For at least one of the above problems, the embodiments of the present disclosure provide an AI monitoring device and method.

According to an aspect of the embodiments of the present disclosure, an AI monitoring method is provided, including:
a network device receives a signal or information transmitted by a terminal equipment; and
the network device performs monitoring or performance evaluation on an AI/ML model in the network device and/or the terminal equipment according to the signal or information.

According to another aspect of the embodiments of the present disclosure, an AI monitoring device is provided, including:
a receiving unit configured to receive a signal or information transmitted by a terminal equipment; and
a processing unit configured to perform monitoring or performance evaluation on an AI/ML model in the network device and/or the terminal equipment according to the signal or information.

According to another aspect of the embodiments of the present disclosure, an AI monitoring method is provided, including:
a terminal equipment receives a signal or information transmitted by a network device; and
the terminal equipment performs monitoring or performance evaluation on an AI/ML model in the network device and/or the terminal equipment according to the signal or information.

According to another aspect of the embodiments of the present disclosure, an AI monitoring device is provided, including:
a receiving unit configured to receive a signal or information transmitted by a network device; and
a processing unit configured to perform monitoring or performance evaluation on an AI/ML model in the network device and/or the terminal equipment according to the signal or information.

According to a further aspect of the embodiments of the present disclosure, a communication system is provided, including:
a terminal equipment configured to receive a signal or information transmitted by a network device, and perform monitoring or performance evaluation on an AI/ML model in the network device and/or the terminal equipment according to the signal or information; and/or
the network device configured to receive a signal or information transmitted by the terminal equipment, and perform monitoring or performance evaluation on the AI/ML model in the network device and/or the terminal equipment according to the signal or information.

One of advantageous effects of the embodiments of the present disclosure lies in: a network device performs monitoring or performance evaluation on an AI/ML model in the network device and/or a terminal equipment according to a signal or information from the terminal equipment, or, a terminal equipment performs monitoring or performance evaluation on an AI/ML model in a network device and/or the terminal equipment according to a signal or information from the network device; hence, AI/ML model running may be monitored, consistency of the AI/ML model running may be maintained, and robustness of the model running may be improved.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system in the embodiments of the present disclosure;

FIG. 2 is a schematic diagram of an AI monitoring method in the embodiments of the present disclosure;

FIG. 3 is a schematic diagram in which a network device monitors an AI/ML model of a terminal equipment in the embodiments of the present disclosure;

FIG. 4 is a schematic diagram of CSI estimation and report in the embodiments of the present disclosure;

FIG. 5 is a schematic diagram of beam management or beam prediction in the embodiments of the present disclosure;

FIG. 6 is a schematic diagram of beam estimation or prediction in the embodiments of the present disclosure;

FIG. 7 is a schematic diagram in which a network device monitors an AI/ML model of the network device in the embodiments of the present disclosure;

FIG. 8 is a schematic diagram of an AI monitoring method in the embodiments of the present disclosure;

FIG. 9 is a schematic diagram in which a terminal equipment monitors an AI/ML model of a network device in the embodiments of the present disclosure;

FIG. 10 is a schematic diagram in which a terminal equipment monitors an AI/ML model of the terminal equipment in the embodiments of the present disclosure;

FIG. 11 is a schematic diagram of an AI monitoring device in the embodiments of the present disclosure;

FIG. 12 is another schematic diagram of an AI monitoring device in the embodiments of the present disclosure;

FIG. 13 is a schematic diagram of a network device in the embodiments of the present disclosure; and

FIG. 14 is a schematic diagram of a terminal equipment in the embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and 5G, New Radio (NR), future 6G and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.). And the term “BS” may include their some or all functions, each BS may provide communication coverage to a specific geographic region. The term “a cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment may be fixed or mobile, and may also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

The scenarios of the embodiments of the present disclosure are described through the following examples, however the present disclosure is not limited to these.

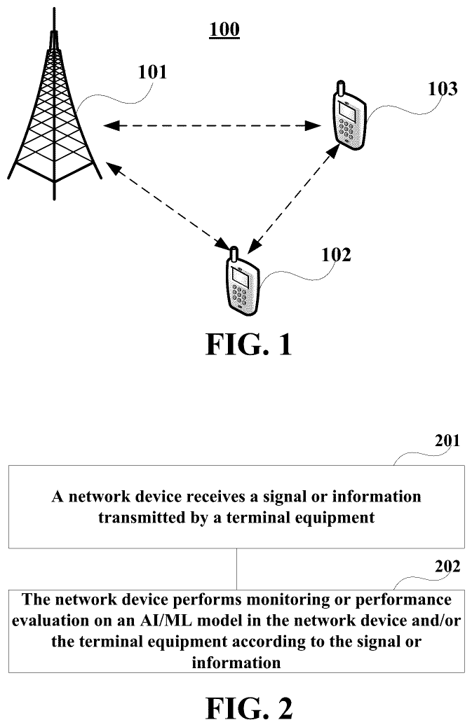

FIG. 1 is a schematic diagram of a communication system in the embodiments of the present disclosure, schematically describes situations by taking a terminal equipment and a network device as examples, as shown in FIG. 1, a communication system 100 may include a network device 101 and terminal equipments 102, 103. For simplicity, FIG. 1 only takes two terminal equipments and one network device as examples for description, however the embodiments of the present disclosure are not limited to this.

In the embodiments of the present disclosure, transmission of existing or further implementable services may be carried out between the network device 101 and the terminal equipments 102, 103. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 1 shows that two terminal equipments 102 and 103 are within the coverage of network device 101, but the present disclosure is not limited to this. The two terminal equipments 102 and 103 may be outside the coverage of the network device 101, or one terminal equipment 102 may be within the coverage of the network device 101 and the other terminal equipment 103 may be outside the coverage of the network device 101.

In the embodiments of the present disclosure, high layer signaling may be e.g. radio resource control (RRC) signaling; for example, is called an RRC message, for example includes an MIB, system information, and a dedicated RRC message; or is called an RRC information element (RRC IE). The high layer signaling, for example, may further be Medium Access Control (MAC) signaling; or called a MAC control element (MAC CE). However, the present disclosure is not limited to these.

In the embodiments of the present disclosure, one or more AI/ML models may be configured and run in a network device and/or a terminal equipment. The AI/ML model may be used for various signal processing functions of wireless communication, such as CSI estimation and reporting, beam management and beam prediction, etc.; the present disclosure is not limited to this.

### Embodiments of a First Aspect

The embodiments of the present disclosure provide an AI monitoring method, which is described from a network device side. In the embodiments of a first aspect, a network device monitors an AI/ML model.

FIG. 2 is a schematic diagram of an AI monitoring method in the embodiments of the present disclosure. As shown in FIG. 2, the method includes:
201, a network device receives a signal or information transmitted by a terminal equipment; and
202, the network device performs monitoring or performance evaluation on an AI/ML model in the network device and/or the terminal equipment according to the signal or information.

It should be noted that the above FIG. 2 is only schematic description of the embodiments of the present disclosure, but the present disclosure is not limited to this. For example, an execution order of each operation may be adjusted appropriately, moreover other some operations may be increased or reduced. Persons skilled in the art may make appropriate modifications according to the above contents, not limited to the records in the above FIG. 2.

In some embodiments, AI/ML models may be run respectively for different signal processing functions. For example, for an AI/ML model for CSI reporting, there may have different model group identifiers, model identifiers, and version identifiers. For an AI/ML model for beam management, there may have additional model group identifiers, model identifiers, and version identifiers.

In some embodiments, the network device performs monitoring or performance evaluation on an AI/ML model in the terminal equipment, and in a case where the performance of the AI/ML model satisfies a predetermined condition, the network device transmits instruction information for stopping the AI/ML model to the terminal equipment.

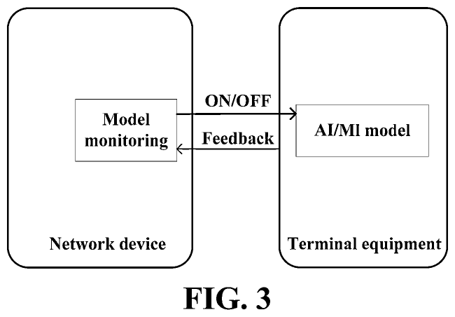

FIG. 3 is a schematic diagram in which a network device monitors an AI/ML model of a terminal equipment in the embodiments of the present disclosure. As shown in FIG. 3, the network device may receive a direct output signal from the AI/ML model of the terminal equipment or a signal related to the output of the AI model, such as the feedback signal in FIG. 3.

The network device may monitor the performance of the AI/ML model at the terminal equipment side, according to the feedback signal. When the performance does not reach a certain indicator, the network device determines or infers that the processing performance of the AI/ML model at the terminal equipment side is not good, so it may transmit a stop instruction to the terminal equipment, and the terminal equipment stops the AI/ML model. In addition, the network device may simultaneously or respectively instruct the terminal equipment to switch to a non-AI processing traditional mode for operation, thus ensuring stable and uninterrupted communication performance.

In some embodiments, the signal or information transmitted by the terminal equipment is a signal or information related to the AI/ML model in the terminal equipment for a signal processing function. For example, it may be feedback information related to CSI, or, an uplink signal related to beam management, and so on.

In some embodiments, the instruction information further includes identification information of the AI/ML model, and/or, the instruction information further instructs the terminal equipment to switch to non-AI/ML processing corresponding to a signal processing function. The identification information of the AI/ML model including at least one of the following: a signal processing function identifier to which the AI/ML model corresponds, an identifier of the AI/ML model, a model group identifier of the AI/ML model, or an intra-group identifier of the AI/ML model.

For example, considering AI/ML models of multiple functions may run simultaneously, and ON/OFF information indications for model monitoring contain identification information of the AI model. For example, an AI/ML model with an index being 2 in a model group 2 for CSI feedback is instructed to be stopped.

The description is first made below by taking CSI estimation and reporting as an example.

In some embodiments, the AI/ML model operates in a terminal equipment and is used for channel state information (CSI) estimation or prediction, and the network device monitors hybrid automatic retransmission request (HARQ) feedback information from the terminal equipment, and performs performance evaluation on the AI/ML model according to the HARQ feedback information.

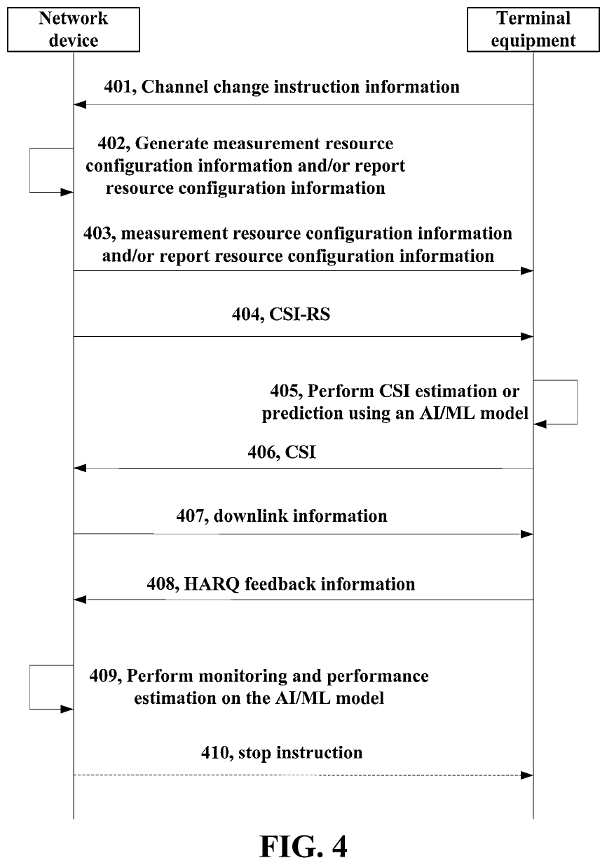

FIG. 4 is a schematic diagram of CSI estimation and reporting in the embodiments of the present disclosure. As shown in FIG. 4, the method includes:
404, a network device transmits a CSI-RS;
405, a terminal equipment performs CSI estimation or prediction;
the network device configures and instructs the terminal equipment to perform CSI estimation and reporting; the terminal equipment performs CSI estimation or prediction by using the AI/ML model;
406, the network device receives CSI reported by the terminal equipment;

The reported CSI may include CQI, PMI, RI, CRI, etc., the present disclosure is not limited to this.
407, the network device transmits downlink information according to the reported CSI; and
408, the network device receives HARQ feedback information transmitted by the terminal equipment, wherein the HARQ feedback information is generated by the terminal equipment based on the downlink information.

As shown in FIG. 4, the method may further include:
409, the network device performs monitoring and performance estimation of the AI/ML model according to HARQ ACK/NCK.

For example, if a predetermined condition (such as too much NACK feedbacks over a period of time) is satisfied, it may be determined that CSI estimated or predicted by the AI/ML model is inaccurate, whereby the AI/ML model may be stopped.

As shown in FIG. 4, the method may further include:
410, the network device transmits a stop instruction for stopping the AI/ML model to the terminal equipment.

Accordingly, the network device side may monitor the AI/ML model according to CSI from an opposite side.

In some embodiments, as shown in FIG. 4, the method may further include:
401, the network device receives channel change instruction information transmitted by the terminal equipment, the channel change instruction information including information on a change of a channel between the network device and the terminal equipment in a time domain and/or a frequency domain and/or a space domain;

For example, the terminal equipment may report its own speed information and motion direction information, etc. to the network device, the present disclosure is not limited to this. In addition, it may further be other information on a change of a channel in a time dimension, a frequency dimension or a spatial dimension.
402, the network device generates measurement resource configuration information and/or reporting resource configuration information according to the channel change instruction information;
403, the network device transmits the measurement resource configuration information and/or the reporting resource configuration information to the terminal equipment.

It should be noted that the above FIG. 4 is only schematic description of the embodiments of the present disclosure, but the present disclosure is not limited to this. For example, an execution order of each operation may be adjusted appropriately, moreover other some operations may be increased or reduced. Persons skilled in the art may make appropriate modifications according to the above contents, not limited to the records in the above FIG. 4.

The description is then made below by taking beam management or beam prediction as an example.

In some embodiments, the AI/ML model operates in the terminal equipment and is used for beam management or beam prediction, and the network device monitors an uplink signal from the terminal equipment, and performs performance evaluation on the AI/ML model according to the uplink signal.

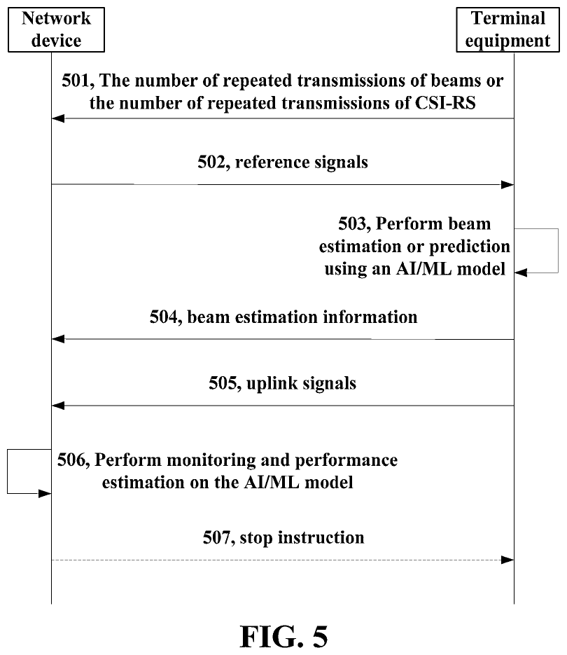

FIG. 5 is a schematic diagram of beam management or beam prediction in the embodiments of the present disclosure. As shown in FIG. 5, the method includes:
501, a network device receives the number of repeated transmissions of beams or the number of repeated transmissions of CSI-RS transmitted by a terminal equipment;
502, the network device transmits reference signals according to the number of repeated transmissions of beams or the number of repeated transmissions of CSI-RS;
503, the terminal equipment performs beam estimation by using the AI/ML model to obtain beam estimation information;

For example, the terminal equipment receives reference signals in the same direction or of the same CSI-RS resource from the network device by using receiving beams in different receiving directions. The terminal equipment estimates an optimal receiving beam direction, or an RS identifier of a space domain QCL in an optimal beam direction, by using the AI/ML model.
504, the network device receives beam estimation information reported by the terminal equipment;

For example, the beam estimation information includes QCL information, an RS identifier, etc., the present disclosure is not limited to this.
505, the network device receives an uplink signal transmitted by the terminal equipment, wherein the uplink signal is generated by the terminal equipment based on the beam estimation information.

As shown in FIG. 5, the method may further include:
506, the network device may perform monitoring and performance estimation of the AI/ML model according to the uplink signal.

For example, the network device compares a strength of the uplink signal generated based on the beam estimation information with a strength of an uplink signal in other direction to evaluate the performance of the AI/ML model. For example, if a comparison result satisfies a predetermined condition, it may be determined that beam information estimated or predicted by the AI/ML model is inaccurate, whereby the AI/ML model may be stopped.

As shown in FIG. 5, the method may further include:
507, the network device transmits a stop instruction for stopping the AI/ML model to the terminal equipment.

Accordingly, the network device side may monitor the AI/ML model according to beam information of an opposite side.

It should be noted that the above FIG. 5 is only schematic description of the embodiments of the present disclosure, but the present disclosure is not limited to this. For example, an execution order of each operation may be adjusted appropriately, moreover other some operations may be increased or reduced. Persons skilled in the art may make appropriate modifications according to the above contents, not limited to the records in the above FIG. 5.

The terminal equipment may perform beam management by using the AI/ML model, in particular, achieve rapid selection or estimation of a beam direction by using the AI/ML model. The terminal equipment may transmit the number of repeated transmissions of one corresponding beam, or the number of repeated transmissions of one CSI-RS to the network device.

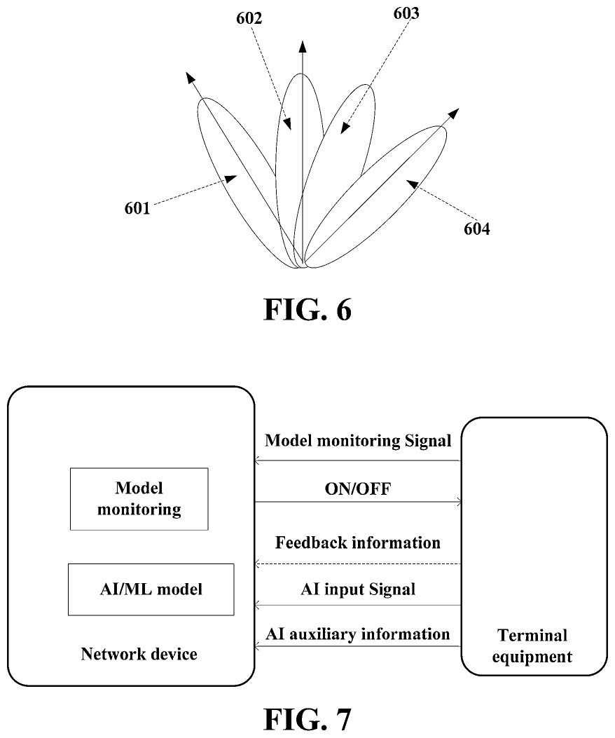

FIG. 6 is a schematic diagram of beam estimation or prediction in the embodiments of the present disclosure. As shown in FIG. 6, the terminal equipment may receive reference signals in the same direction or of the same CSI-RS resource from the network device by using receiving beams (as shown by 601 and 604 in FIG. 6) in different receiving directions. By receiving reference signals transmitted by the network device, the terminal equipment estimates an intensity of un-transmitted beams (as shown by 602 and 603 in FIG. 6) and selects the strongest beam direction (602 in FIG. 6), by using the AI/ML model.

Since the network device only transmits two beams, the terminal equipment is able to obtain a maximum beam direction, saving 50% of the overhead compared to a beam selection scheme in which a beam is repeatedly transmitted four times in a traditional method. The terminal equipment may report space domain QCL information of its selected beam direction, such as SSB ID or CSI-RS ID, to the network device.

The network device may evaluate the performance of a model at a terminal equipment side by monitoring a strength of an uplink signal or a strength of a downlink signal corresponding to the beam direction. When a certain condition is satisfied, the network device determines that AI performance of the terminal equipment side is not good, and may notify the terminal equipment to stop the operation of the AI/ML model.

In some embodiments, the AI/ML model operates in the terminal equipment and is used for beam management or beam prediction, and the network device monitors HARQ feedback information from the terminal equipment, and performs performance evaluation on the AI/ML model according to the HARQ feedback information.

In some embodiments, the network device configures and instructs the terminal equipment to perform beam prediction, the terminal equipment performing beam prediction by using the AI/ML model, the network device receives the beam prediction information reported by the terminal equipment, transmits downlink information according to the reported beam prediction information, and receives HARQ feedback information transmitted by the terminal equipment, wherein the HARQ feedback information is generated by the terminal equipment based on the downlink information.

In some embodiments, the network device receives channel change instruction information transmitted by the terminal equipment, the channel change instruction information including information on a change of a channel between the network device and the terminal equipment in a time domain and/or a frequency domain and/or a space domain, the network device generates beam prediction configuration according to the channel change instruction information, and transmits the beam prediction configuration information to the terminal equipment.

For example, the terminal equipment performs beam prediction by using the AI/ML model, the terminal equipment estimates a beam direction for a future period, or a QCL indication associated with transmitting beams, and transmits these information to the network device. In order to predict a beam, the terminal equipment may further transmit channel time domain change information to the network device, and the network device adjusts a density of RS used for measurement.

For another example, the AI/ML model of the terminal equipment predicts a future beam direction or QCL information based on RS and previous beam estimation results, and transmits a corresponding RS ID to the network device; with reference to these information, the network device uses a beam in the QCL direction to transmit at a relevant moment.

The network device determines the performance of the AI/ML model by monitoring HARQ feedback information of the terminal equipment. When a certain condition is satisfied, the network device determines that the performance of the AI/ML model is not good, and notifies the terminal equipment to stop the operation of the AI/ML model.

For a further example, the network device schedules the terminal equipment to transmit an uplink SRS, the SRS and an RS corresponding to other downlink directions are QCL. The network device compares a strength of an SRS in other direction with a strength of an SRS in a downlink direction selected by the terminal equipment, and evaluates the performance of the AI/ML model with respect to beam management or prediction by using uplink and downlink channel reciprocity. When a certain condition is satisfied, the network device determines that the performance of an AI/ML model at the terminal equipment side is not good, and notifies the terminal equipment to stop the operation of the AI/ML model.

In some embodiments, the network device performs monitoring or performance evaluation on the AI/ML model in the network device, and in a case where the performance of the AI/ML model satisfies the predetermined condition, the network device stops the AI/ML model.

FIG. 7 is a schematic diagram in which a network device monitors an AI/ML model of the network device in the embodiments of the present disclosure. As shown in FIG. 7, the performance monitoring of AI/ML at the network device side may be realized by a model monitoring module within the network device. The model monitoring module may configure or schedule the terminal equipment to transmit a model monitoring signal for the network device to monitor the model. Or, the model monitoring module may further monitor the model via feedback information of the terminal equipment. When the performance does not reach a certain indicator, the network device determines or infers that the processing performance of the AI/ML model is not good, and the network device stops using the AI/ML model internally, and uses a non-AI processing mode.

In some embodiments, the signal or information transmitted by the terminal equipment includes at least one of the following: a sounding reference signal (SRS), reference signal received power (RSRP), HARQ feedback information, beam failure request information, or beam failure recovery (BFR) information.

For example, the network device performs downlink beam estimation by using the AI/ML model. The network device may estimate a signal strength in an un-transmitted beam direction and further find a maximum beam direction by transmitting a small number of beams to the terminal equipment, via RSRP report information of the terminal equipment and by using the AI/ML model. Use of AI/ML speeds up a beam scanning speed and also reduces overhead.

The network device may determine the accuracy of its AI/ML model for downlink beam estimation by measuring strength of uplink signals in a selected maximum beam direction and in other beam direction, such as a strength of an SRS signal, reciprocity of uplink and downlink channels may be exploited here. The model monitoring signal in FIG. 7 may be an SRS signal. When the performance does not reach a certain indicator, the network device determines that the performance of the AI/ML model is not good, and the network device stops using the AI/ML model internally, and uses a non-AI processing mode.

Or, after the network device selects an optimum beam by using the AI/ML model, the network device transmits data to the terminal equipment by using the beam. The terminal equipment will perform beam failure recovery (BFR) if a beam failure occurs, and the network device monitors the quality of the AI/ML model according to the statistics of beam failure recovery requests. When the performance does not reach a certain indicator, the network device determines that the performance of the AI/ML model is not good, and the network device stops using the AI/ML model internally, and uses a non-AI processing mode.

For another example, the network device performs beam management by using the AI/ML model. Specifically, the network device transmits a group of beams (more than one beam) or a related group of CSI-RS, and then the network device receives a measurement result of the terminal equipment for said signal. The network device generates an estimate of the un-transmitted beam by using the AI/ML model and based on the measured result, and then selects an optimal transmitting beam for the terminal equipment.

In order to monitor AI/ML performance, the network device may configure a relevant AI/ML monitoring configuration and a report configuration for the terminal equipment. The terminal equipment reports AI/ML-related performance information according to these configurations. The network device may configure the terminal equipment with one or more RS configurations corresponding to beam(s) selected based on AI/ML, and/or configure a relevant metric and threshold.

The terminal equipment may determine a beam condition based on a criterion of a beam failure determination procedure, and according to a measurement result of a beam corresponding to Beam-Failure-Detection-RS-ResourceConfig, and perform a beam failure recovery procedure. The network device may evaluate a status of the BFR, and when a certain condition is satisfied (such as the number of times of beam failures is too many per unit of time, etc.), the network device determines that the AI/ML performance is not good, and stops using the AI/ML model.

For another example, the network device performs uplink beam selection by using the AI/ML model. The network device may schedule the terminal equipment to transmit a small number of SRS or beams, and estimate an optimal terminal uplink beam direction by using AI/ML. In order to verify the performance of the model, the network device may verify whether the direction selected by its AI/ML is an optimal direction by transmitting a downlink beam and letting the terminal equipment report the RSRP, so as to determine the performance of the model. For example, the model monitoring signal in FIG. 7 is RSRP information corresponding to measurement reporting of a CSI-RS signal for a downlink beam. When the performance does not reach a certain indicator, the network device determines that the processing performance of the AI/ML model is not good, and the network device stops using the AI/ML model internally, and uses a non-AI processing mode.

Schematic description is made above for “a network device monitors an AI/ML model”. Schematic description is made below for monitoring of an AI/ML model in a cell or an area.

For example, regardless of a network device side or a terminal equipment side, an AI/ML model is generally very robust, and model stopping is a rare occurrence. For the network device side, its AI/ML model is generally not for a user to serve, and a performance feedback from the user may not be accurate enough.

Therefore, the network device side needs to make a determination according to feedback information of multiple terminal equipments. Similarly, the network device side cannot determine that the performance of a certain model at the terminal equipment side is problematic via monitoring of a certain model at the terminal equipment side. It is necessary to stop the use of the same class of models when the performance of the same class of models in multiple terminal equipments does not meet a requirement.

In some embodiments, the network device performs monitoring or performance evaluation on an AI/ML model in a cell, and in a case where the number of terminal equipments with the performance of the AI/ML model satisfying the predetermined condition reaches a threshold, the network device determines to stop the AI/ML model.

For example, the network device monitors an output signal or a signal related to output of an AI/ML model of one or more terminal equipments. When it is determined that the number of terminal equipments with poor performance reaches a certain condition, the network device determines that this kind of AI/ML model is not suitable for application in a terminal equipment of a current cell.

For example, the network device monitors AI/ML performance of the terminal equipment via metric information such as HARQ NACK or beam failure recovery, and when monitoring that multiple users are experiencing poor performance on related metrics, and a certain condition is reached, the network device decides to stop AI/ML at the terminal equipment side and tells all terminal equipments using the AI/ML model to stop using the AI/ML model.

In some embodiments, the network device broadcasts identification information of an AI/ML model in the cell with performance lower than the threshold via system information in the cell, and/or, broadcasts identification information of an AI/ML model in the cell with performance higher than the threshold via system information in the cell.

For example, the network device includes a poor-performance AI/ML model identifier into an exclusion list of an AI/ML model of a cell corresponding to the network device, and broadcasts it as system information in the cell. The exclusion list includes an AI model function identifier and a corresponding AI model identifier. In addition, it may further include an AI model group identifier and an intra-group identifier corresponding to an AI function, etc. Similarly, a model identifier of an AI/ML model at a terminal equipment side, which is identified by other network device through model monitoring that it has poor performance and is judged that it needs to be disabled, may further be included in the exclusion list of the AI/ML model of the cell.

For another example, the network device may further accumulate a list of models with particularly good AI/ML performance, used by a terminal equipment, and put it into a permission list of an AI/ML model of a cell, and broadcast it as system information in the cell. The permission list includes an AI model function identifier and a corresponding AI model identifier. In addition, it may further include an AI model group identifier and an intra-group identifier corresponding to an Al function, etc.

In some embodiments, the network device configures cell-specific configuration information for one or more terminal equipments, so that the one or more terminal equipments feed(s) back a signal or information for monitoring an AI/ML model according to the configuration information.

For example, the network device configures model monitoring configuration information for a terminal equipment in a cell by using cell-specific configuration information, which is used to enable the terminal equipment to feed back an AI performance feedback or monitoring information for a function. This configuration may include a measurement configuration, a report configuration and a monitoring indicator configuration.

The monitoring indicator configuration may include metric information on monitoring, such as RSRP, HARQ-NACK, an event counter, a timer, and threshold information corresponding to the indicator. The measurement information may include an RS type of measurement, such as SSB, CSI-RS, etc., and a measurement resource configuration. The report configuration includes report modes and resources, such as periodic report, semi-persistent report, and aperiodic report, etc.

After receiving the model monitoring configuration information, the terminal equipment performs reporting according to a configuration. The network device determines the performance of the AI/ML model according to the received report information. Through statistics reported by multiple terminal equipments, and when certain conditions are reached, the network device determines that the performance of the AI/ML model is not good, and stops the AI/ML model.

In some embodiments, the network device transmits identification information of an AI/ML model in the cell with performance lower than the threshold to another cell or a core network device, and/or transmits identification information of an AI/ML model in the cell with performance higher than the threshold to another cell or a core network device.

For example, the exclusion list and/or the permission list of the AI/ML model may be transmitted to an adjacent network device, or may be transmitted to a core network device.

For another example, in the above model monitoring configuration information, a monitoring metric and a threshold indicator of an excellent model, as well as corresponding measurement configuration and report configuration, may be further configured. After receiving report statistics of multiple terminal equipments for the excellent model, the network device may recommend or share the model identifier to an adjacent cell or core network.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, the network device performs monitoring or performance evaluation on an AI/ML model in the network device and/or the terminal equipment according to a signal or information from the terminal equipment; hence, AI/ML model running may be monitored, consistency of the AI/ML model running may be maintained, and robustness of the model running may be improved.

### Embodiments of a Second Aspect

The embodiments of the present disclosure provide an AI monitoring method, which is described from a terminal equipment side, the contents same as the embodiments of the first aspect are not repeated. In the embodiments of the second aspect, a terminal equipment monitors an AI/ML model.

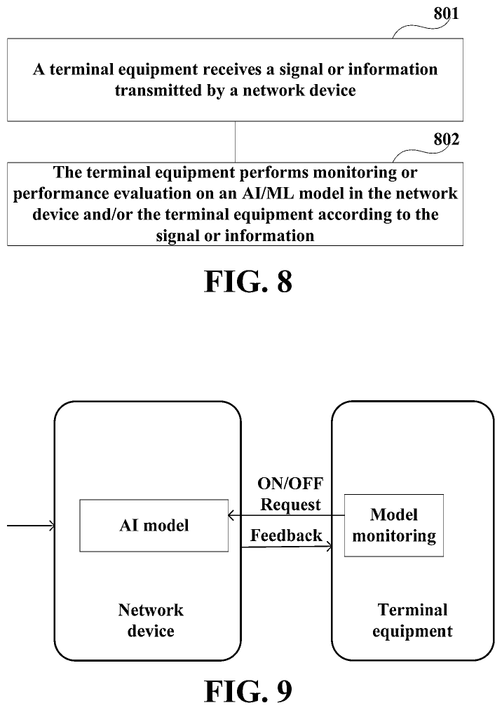

FIG. 8 is a schematic diagram of an AI monitoring method in the embodiments of the present disclosure, as shown in FIG. 8, the method includes:
801, a terminal equipment receives a signal or information transmitted by a network device; and
802, the terminal equipment performs monitoring or performance evaluation on an AI/ML model in the network device and/or the terminal equipment according to the signal or information.

It should be noted that the above FIG. 8 is only schematic description of the embodiments of the present disclosure, but the present disclosure is not limited to this. For example, an execution order of each operation may be adjusted appropriately, moreover other some operations may be increased or reduced. Persons skilled in the art may make appropriate modifications according to the above contents, not limited to the records in the above FIG. 8.

In some embodiments, the terminal equipment performs monitoring or performance evaluation on the AI/ML model in the network device, and in a case where the performance of the AI/ML model satisfies the predetermined condition, the terminal equipment transmits request information for stopping the AI/ML model to the network device.

FIG. 9 is a schematic diagram in which a terminal equipment monitors an AI/ML model of a network device in the embodiments of the present disclosure. As shown in FIG. 9, the network device uses AI/ML to achieve a certain function, and the terminal equipment may determine the performance of the AI/ML model at the network device side by receiving a signal or information. When the performance does not reach a certain indicator or condition, the terminal equipment determines that the performance of the AI/ML model is not good, and the terminal equipment may not be able to directly instruct the network device to stop its AI/ML model, and may transmit a relevant request for stopping the AI/ML model to the network device, and/or, transmit a request to enable relevant non-AI processing.

In some embodiments, the request information includes at least one of the following: a stop request for the AI/ML model, identification information for the AI/ML model or AI/ML model group, an identifier of a signal processing function to which the AI/ML model corresponds, a start request for non-AI processing, or identification information for non-AI processing.

In some embodiments, the terminal equipment receives configuration information for AI/ML monitoring, transmitted by the network device.

For example, the network device configures the terminal equipment with a measurement configuration, a report configuration and a monitoring indicator configuration for model monitoring. The monitoring indicator configuration may include metric information on monitoring, such as RSRP, HARQ-NACK, an event counter, a timer, and threshold information corresponding to the indicator. The measurement information may include an RS type of measurement, such as SSB, CSI-RS, etc., and a measurement resource configuration. The report configuration includes report modes and resources, such as periodic report, semi-persistent report, and aperiodic report, etc.

In some embodiments, the terminal equipment performs monitoring or performance evaluation on the AI/ML model in the terminal equipment, and in a case where the performance of the AI/ML model satisfies the predetermined condition, the terminal equipment transmits request information for stopping the AI/ML model to the network device.

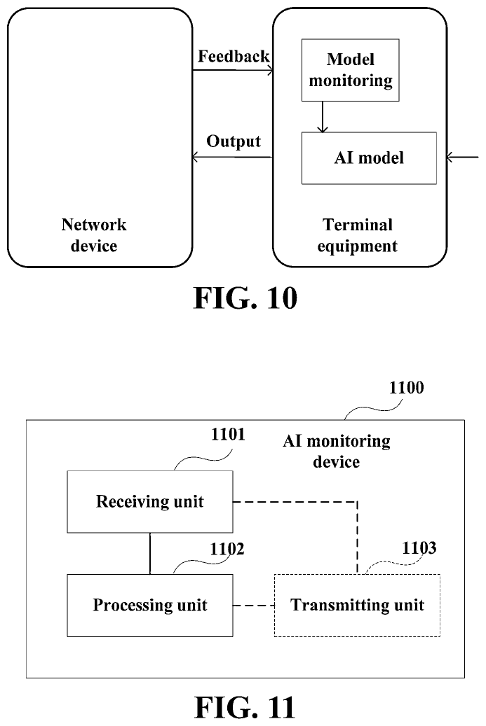

FIG. 10 is a schematic diagram in which a terminal equipment monitors an AI/ML model of the terminal equipment in the embodiments of the present disclosure. As shown in FIG. 10, the terminal equipment uses AI/ML to achieve a certain function, and the terminal equipment may determine the performance of the AI/ML model at the terminal equipment side by receiving a signal or information from a network device. When the performance does not reach a certain indicator or condition, the terminal equipment determines that the performance of the AI/ML model is not good, the terminal equipment for example cannot directly stop its AI/ML model, the terminal equipment may transmit a relevant request for stopping the AI/ML model to the network device, and/or, transmit a request to enable relevant non-AI processing.

In some embodiments, the terminal equipment receives an AI capability query request transmitted by the network device; and feeds back an AI/ML capability and/or AI monitoring capability to the network device.

For example, the network device inquires about AI/ML-related capabilities at the terminal equipment side, including one or more of the following: AI function support query, AI model monitoring capability query, AI corresponding processing function query, and so on. The terminal equipment may make a response or report correspondingly according to a query request.

For another example, in a case where the terminal equipment has an AI capability and is capable of performing model monitoring, the network device configures the terminal equipment with a measurement configuration, a report configuration and a monitoring indicator configuration for model monitoring. The monitoring indicator configuration may include metric information on monitoring, such as RSRP, HARQ-NACK, an event counter, a timer, and threshold information corresponding to the indicator. The measurement information may include an RS type of measurement, such as SSB, CSI-RS, etc., and a measurement resource configuration. The report configuration includes report modes and resources, such as periodic report, semi-persistent report, and aperiodic report, etc.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, the terminal equipment performs monitoring or performance evaluation on an AI/ML model in the network device and/or the terminal equipment according to a signal or information from the network device; hence, AI/ML model running may be monitored, consistency of the AI/ML model running may be maintained, and robustness of the model running may be improved.

### Embodiments of a Third Aspect

Embodiments of the present disclosure provide an AI monitoring device. The device may be a network device, or may be one or more parts or components configured in the network device. The contents same as the embodiments of the first aspect are not repeated.

FIG. 11 is a schematic diagram of an AI monitoring device in the embodiments of the present disclosure. As shown in FIG. 11, an AI monitoring device 1100 includes:
a receiving unit 1101 configured to receive a signal or information transmitted by a terminal equipment; and
a processing unit 1102 configured to perform monitoring or performance evaluation on an AI/ML model in the network device and/or the terminal equipment according to the signal or information.

In some embodiments, the network device performs monitoring or performance evaluation on the AI/ML model in the terminal equipment. As shown in FIG. 11, the device further includes:
a transmitting unit 1103 configured to, in a case where the performance of the AI/ML model satisfies a predetermined condition, transmit instruction information for stopping the AI/ML model to the terminal equipment.

In some embodiments, the signal or information transmitted by the terminal equipment is a signal or information related to the AI/ML model in the terminal equipment for a signal processing function.

In some embodiments, the instruction information further includes identification information of the AI/ML model, and/or, the instruction information further instructs the terminal equipment to switch to non-AI/ML processing corresponding to a signal processing function;
the identification information of the AI/ML model including at least one of the following: a signal processing function identifier to which the AI/ML model corresponds, an identifier of the AI/ML model, a model group identifier of the AI/ML model, or an intra-group identifier of the AI/ML model.

In some embodiments, the AI/ML model operates in the terminal equipment and is used for channel state information (CSI) estimation or prediction, and the network device monitors hybrid automatic retransmission request (HARQ) feedback information from the terminal equipment, and performs performance evaluation on the AI/ML model according to the HARQ feedback information.

In some embodiments, the network device configures and instructs the terminal equipment to perform CSI estimation and reporting, the terminal equipment performing CSI estimation and reporting by using the AI/ML model, the network device receives CSI reported by the terminal equipment, transmits downlink information according to the reported CSI, and receives HARQ feedback information transmitted by the terminal equipment, wherein the HARQ feedback information is generated by the terminal equipment based on the downlink information.

In some embodiments, the network device receives channel change instruction information transmitted by the terminal equipment, the channel change instruction information including information on a change of a channel between the network device and the terminal equipment in a time domain and/or a frequency domain and/or a space domain, the network device generates measurement resource configuration information and/or report resource configuration information according to the channel change instruction information, and transmits the measurement resource configuration information and/or the report resource configuration information to the terminal equipment.

In some embodiments, the AI/ML model operates in the terminal equipment and is used for beam management or beam prediction, and the network device monitors an uplink signal from the terminal equipment, and performs performance evaluation on the AI/ML model according to the uplink signal.

In some embodiments, the network device receives the number of repeated transmissions of beams or the number of repeated transmissions of CSI-RS transmitted by the terminal equipment, transmits reference signals according to the number of repeated transmissions of beams or the number of repeated transmissions of CSI-RS, the terminal equipment performing beam estimation by using the AI/ML model to obtain beam estimation information, the network device receives the beam estimation information reported by the terminal equipment, and receives uplink signals transmitted by the terminal equipment, wherein the uplink signals are generated by the terminal equipment based on the beam estimation information.

In some embodiments, the AI/ML model operates in the terminal equipment and is used for beam management or beam prediction, and the network device monitors HARQ feedback information from the terminal equipment, and performs performance evaluation on the AI/ML model according to the HARQ feedback information.

In some embodiments, the network device configures and instructs the terminal equipment to perform beam prediction, the terminal equipment performing beam prediction by using the AI/ML model, the network device receives the beam prediction information reported by the terminal equipment, transmits downlink information according to the reported beam prediction information, and receives HARQ feedback information transmitted by the terminal equipment, wherein the HARQ feedback information is generated by the terminal equipment based on the downlink information.

In some embodiments, the network device performs monitoring or performance evaluation on the AI/ML model in the network device, and in a case where the performance of the AI/ML model satisfies the predetermined condition, the network device stops the AI/ML model.

In some embodiments, the signal or information transmitted by the terminal equipment includes at least one of the following: a sounding reference signal (SRS), reference signal received power (RSRP), HARQ feedback information, beam failure request information, or beam failure recovery (BFR) information.

In some embodiments, the network device performs monitoring or performance evaluation on an AI/ML model in a cell, and in a case where the number of terminal equipments with the performance of the AI/ML model satisfying the predetermined condition reaches a threshold, the network device determines to stop the AI/ML model.

In some embodiments, the network device broadcasts identification information of an AI/ML model in the cell with performance lower than the threshold via system information in the cell, and/or, broadcasts identification information of an AI/ML model in the cell with performance higher than the threshold via system information in the cell.

In some embodiments, the network device configures cell-specific configuration information for one or more terminal equipments, so that the one or more terminal equipments feed(s) back a signal or information for monitoring an AI/ML model according to the configuration information.

In some embodiments, the network device transmits identification information of an AI/ML model in the cell with performance lower than the threshold to another cell or a core network device, and/or transmits identification information of an AI/ML model in the cell with performance higher than the threshold to another cell or a core network device.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above only describes components or modules related to the present disclosure, but the present disclosure is not limited to this. The AI monitoring device 1100 may further include other components or modules. For detailed contents of these components or modules, relevant technologies may be referred to.

Moreover, for the sake of simplicity, FIG. 11 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

As may be known from the above embodiments, the network device performs monitoring or performance evaluation on an AI/ML model in the network device and/or the terminal equipment according to a signal or information from the terminal equipment; hence, AI/ML model running may be monitored, consistency of the AI/ML model running may be maintained, and robustness of the model running may be improved.

### Embodiments of a Fourth Aspect

Embodiments of the present disclosure provide an AI monitoring device. The device for example may be a terminal equipment, or may be one or more parts or components configured in the terminal equipment. The contents same as the embodiments of the first and second aspects are not repeated.

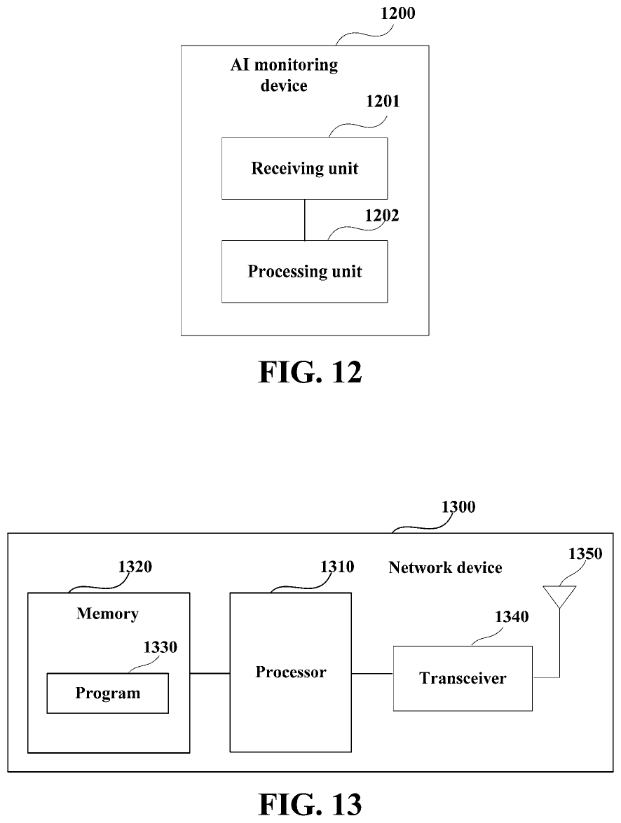

FIG. 12 is a schematic diagram of an AI monitoring device in the embodiments of the present disclosure. As shown in FIG. 12, an AI monitoring device 1200 includes:
a receiving unit 1201 configured to receive a signal or information transmitted by a network device; and
a processing unit 1202 configured to perform monitoring or performance evaluation on an AI/ML model in the network device and/or the terminal equipment according to the signal or information.

In some embodiments, the terminal equipment performs monitoring or performance evaluation on the AI/ML model in the network device, and in a case where the performance of the AI/ML model satisfies the predetermined condition, the terminal equipment transmits request information for stopping the AI/ML model to the network device.

In some embodiments, the terminal equipment performs monitoring or performance evaluation on the AI/ML model in the terminal equipment, and in a case where the performance of the AI/ML model satisfies the predetermined condition, the terminal equipment transmits request information for stopping the AI/ML model to the network device.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above only describes components or modules related to the present disclosure, but the present disclosure is not limited to this. The AI monitoring device 1200 may further include other components or modules. For detailed contents of these components or modules, relevant technologies may be referred to.

Moreover, for the sake of simplicity, FIG. 12 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

As may be known from the above embodiments, the terminal equipment performs monitoring or performance evaluation on an AI/ML model in the network device and/or the terminal equipment according to a signal or information from the network device; hence, AI/ML model running may be monitored, consistency of the AI/ML model running may be maintained, and robustness of the model running may be improved.

### Embodiments of a Fifth Aspect

The embodiments of the present disclosure further provide a communication system, FIG. 1 may be referred to, the contents same as the embodiments of the first to fourth aspects are not repeated.

In some embodiments, the communication system 100 at least may include:
a terminal equipment 102 configured to receive a signal or information transmitted by a network device, and perform monitoring or performance evaluation on an AI/ML model in the network device and/or the terminal equipment according to the signal or information; and/or
the network device 101 configured to receive a signal or information transmitted by the terminal equipment, and perform monitoring or performance evaluation on the AI/ML model in the network device and/or the terminal equipment according to the signal or information.

The embodiments of the present disclosure further provide a network device, for example may be a base station, but the present disclosure is not limited to this, it may also be other network devices.

FIG. 13 is a composition schematic diagram of a network device in the embodiments of the present disclosure. As shown in FIG. 13, a network device 1300 may include: a processor 1310 (such as a central processing unit (CPU)) and a memory 1320; the memory 1320 is coupled to the processor 1310. The memory 1320 may store various data; moreover, also stores a program 1330 for information processing, and executes the program 1330 under the control of the processor 1310.

For example, the processor 1310 may be configured to execute a program to implement the AI monitoring method as described in the embodiments of the first aspect. For example, the processor 1310 may be configured to perform the following control: receive a signal or information transmitted by the terminal equipment, and perform monitoring or performance evaluation on the AI/ML model in the network device and/or the terminal equipment according to the signal or information.

In addition, as shown in FIG. 13, the network device 1300 may further include: a transceiver 1340 and an antenna 1350, etc., wherein the functions of said components are similar to relevant arts, which are not repeated here. It's worth noting that the network device 1300 does not have to include all the components shown in FIG. 13. Moreover, the network device 1300 may further include components not shown in FIG. 13, relevant arts may be referred to.

The embodiments of the present disclosure further provide a terminal equipment, but the present disclosure is not limited to this, it may also be other devices.

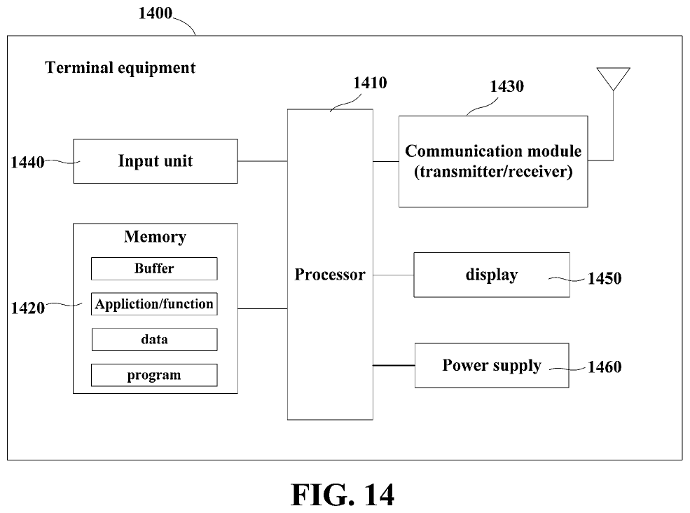

FIG. 14 is a schematic diagram of a terminal equipment in the embodiments of the present disclosure. As shown in FIG. 14, a terminal equipment 1400 may include a processor 1410 and a memory 1420; the memory 1420 stores data and programs, and is coupled to the processor 1410. It's worth noting that this figure is exemplary; other types of structures can also be used to supplement or replace this structure, so as to realize a telecommunication function or other functions.

For example, the processor 1410 may be configured to execute a program to implement the AI monitoring method as described in the embodiments of the second aspect. For example, the processor 1410 may be configured to perform the following control: receive a signal or information transmitted by the network device, and perform monitoring or performance evaluation on the AI/ML model in the network device and/or the terminal equipment according to the signal or information.

As shown in FIG. 14, the terminal equipment 1400 may further include: a communication module 1430, an input unit 1440, a display 1450 and a power supply 1460. The functions of said components are similar to relevant arts, which are not repeated here. It's worth noting that the terminal equipment 1400 does not have to include all the components shown in FIG. 14, said components are not indispensable. Moreover, the terminal equipment 1400 may further include components not shown in FIG. 14, relevant arts can be referred to.

The embodiments of the present disclosure further provide a computer program, wherein when a terminal equipment executes the program, the program enables the terminal equipment to execute the AI monitoring method described in the embodiments of the second aspect.

The embodiments of the present disclosure further provide a storage medium in which a computer program is stored, wherein the computer program enables a terminal equipment to execute the AI monitoring method described in the embodiments of the second aspect.

The embodiments of the present disclosure further provide a computer program, wherein when a network device executes the program, the program enables the network device to execute the AI monitoring method described in the embodiments of the first aspect.

The embodiments of the present disclosure further provide a storage medium in which a computer program is stored, wherein the computer program enables a network device to execute the AI monitoring method described in the embodiments of the first aspect.

The device and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram and/or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram and/or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram and/or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:

1. An AI monitoring method, including:
a network device receives a signal or information transmitted by a terminal equipment; and
performs monitoring or performance evaluation on an AI/ML model in the network device and/or the terminal equipment according to the signal or information.

2. The method according to Supplement 1, wherein the network device performs monitoring or performance evaluation on the AI/ML model in the terminal equipment, and the method further includes:
in a case where the performance of the AI/ML model satisfies a predetermined condition, the network device transmits instruction information for stopping the AI/ML model to the terminal equipment.

3. The method according to Supplement 2, wherein the signal or information transmitted by the terminal equipment is a signal or information related to the AI/ML model in the terminal equipment for a signal processing function.

4. The method according to Supplement 2, wherein the instruction information further includes identification information of the AI/ML model, and/or, the instruction information further instructs the terminal equipment to switch to non-AI/ML processing corresponding to a signal processing function.

5. The method according to Supplement 2, wherein the identification information of the AI/ML model including at least one of the following: a signal processing function identifier to which the AI/ML model corresponds, an identifier of the AI/ML model, a model group identifier of the AI/ML model, or an intra-group identifier of the AI/ML model.

6. The method according to any one of Supplements 2 to 5, wherein the AI/ML model operates in the terminal equipment and is used for channel state information (CSI) estimation or prediction;
the network device monitors hybrid automatic retransmission request (HARQ) feedback information from the terminal equipment, and performs performance evaluation on the AI/ML model according to the HARQ feedback information.

7. The method according to Supplement 6, wherein the method further includes:
the network device configures and instructs the terminal equipment to perform CSI estimation and report; the terminal equipment performing CSI estimation or prediction by using the AI/ML model;
receives CSI reported by the terminal equipment;
transmits downlink information according to the reported CSI; and
receives HARQ feedback information transmitted by the terminal equipment; wherein the HARQ feedback information is generated by the terminal equipment based on the downlink information.

8. The method according to Supplement 7, wherein the method further includes:
the network device receives channel change instruction information transmitted by the terminal equipment, the channel change instruction information including information on a change of a channel between the network device and the terminal equipment in a time domain and/or a frequency domain and/or a space domain;
generates measurement resource configuration information and/or report resource configuration information according to the channel change instruction information;
transmits the measurement resource configuration information and/or the report resource configuration information to the terminal equipment.

9. The method according to any one of Supplements 2 to 5, wherein the AI/ML model operates in the terminal equipment and is used for beam management or beam prediction;
the network device monitors an uplink signal from the terminal equipment, and performs performance evaluation on the AI/ML model according to the uplink signal.

10. The method according to Supplement 9, wherein the method further includes:
the network device receives the number of repeated transmissions of beams or the number of repeated transmissions of CSI-RS transmitted by the terminal equipment;
transmits a reference signal according to the number of repeated transmissions of beams or the number of repeated transmissions of CSI-RS; the terminal equipment performing beam estimation by using the AI/ML model to obtain beam estimation information;
receives the beam estimation information reported by the terminal equipment; and
receives an uplink signal transmitted by the terminal equipment; wherein the uplink signal is generated by the terminal equipment based on the beam estimation information.

11. The method according to Supplement 10, wherein the network device compares a strength of the uplink signal generated based on the beam estimation information with a strength of an uplink signal in other direction to evaluate the performance of the AI/ML model.

12. The method according to any one of Supplements 2 to 5, wherein the AI/ML model operates in the terminal equipment and is used for beam management or beam prediction;
the network device monitors HARQ feedback information from the terminal equipment, and performs performance evaluation on the AI/ML model according to the HARQ feedback information.

13. The method according to Supplement 12, wherein the method further includes:
the network device configures and instructs the terminal equipment to perform beam prediction; the terminal equipment performing beam prediction by using the AI/ML model;
receives beam prediction information reported by the terminal equipment;
transmits downlink information according to the reported beam prediction information; and
receives HARQ feedback information transmitted by the terminal equipment; wherein the HARQ feedback information is generated by the terminal equipment based on the downlink information.

14. The method according to Supplement 13, wherein the method further includes:
the network device receives channel change instruction information transmitted by the terminal equipment, the channel change instruction information including information on a change of a channel between the network device and the terminal equipment in a time domain and/or a frequency domain and/or a space domain;
generates a beam prediction configuration according to the channel change instruction information; and
transmits the beam prediction configuration information to the terminal equipment.

15. The method according to Supplement 1, wherein the network device performs monitoring or performance evaluation on the AI/ML model in the network device, and the method further includes:

in a case where the performance of the AI/ML model satisfies a predetermined condition, the network device stops the AI/ML model.

16. The method according to Supplement 15, wherein the signal or information transmitted by the terminal equipment includes at least one of the following: a sounding reference signal (SRS), reference signal received power (RSRP), HARQ feedback information, beam failure request information, or beam failure recovery (BFR) information.

17. The method according to any one of Supplements 1 to 16, wherein the network device performs monitoring or performance evaluation on an AI/ML model in a cell, and in a case where the number of terminal equipments with the performance of the AI/ML model satisfying the predetermined condition reaches a threshold, the network device determines to stop the AI/ML model.

18. The method according to Supplement 17, wherein the method further includes:
the network device broadcasts identification information of an AI/ML model in the cell with performance lower than the threshold via system information in the cell, and/or, broadcasts identification information of an AI/ML model in the cell with performance higher than the threshold via system information in the cell.

19. The method according to Supplement 17, wherein the method further includes:
the network device configures cell-specific configuration information for one or more terminal equipments, so that the one or more terminal equipments feed(s) back a signal or information for monitoring an AI/ML model according to the configuration information.

20. The method according to Supplement 17, wherein the method further includes:
the network device transmits identification information of an AI/ML model in the cell with performance lower than the threshold to another cell or a core network device, and/or transmits identification information of an AI/ML model in the cell with performance higher than the threshold to another cell or a core network device.

21. An AI monitoring method, including:
a terminal equipment receives a signal or information transmitted by a network device; and
performs monitoring or performance evaluation on an AI/ML model in the network device and/or the terminal equipment according to the signal or information.

22. The method according to Supplement 21, wherein the terminal equipment performs monitoring or performance evaluation on the AI/ML model in the network device, and the method further includes:
in a case where the performance of the AI/ML model satisfies a predetermined condition, the terminal equipment transmits request information for stopping the AI/ML model to the network device.

23. The method according to Supplement 22, wherein the request information includes at least one of the following: a stop request for the AI/ML model, identification information for the AI/ML model or AI/ML model group, an identifier of a signal processing function to which the AI/ML model corresponds, an open request for non-AI processing, or identification information for non-AI processing.

24. The method according to Supplement 22, wherein the method further includes:
the terminal equipment receives configuration information for AI/ML monitoring, transmitted by the network device.

25. The method according to Supplement 21, wherein the terminal equipment performs monitoring or performance evaluation on the AI/ML model in the terminal equipment, and the method further includes:
in a case where the performance of the AI/ML model satisfies a predetermined condition, the terminal equipment transmits request information for stopping the AI/ML model to the network device.

26. The method according to any one of Supplements 21 to 25, wherein the method further includes:
the terminal equipment receives an AI capability query request transmitted by the network device; and
feeds back an AI/ML capability and/or an AI monitoring capability to the network device.

27. A network device, including a memory and a processor, the memory storing a computer program, and the processor being configured to execute the computer program to implement the AI monitoring method according to any one of Supplements 1 to 20.

28. A terminal equipment, including a memory and a processor, the memory storing a computer program, and the processor being configured to execute the computer program to implement the AI monitoring method according to any one of Supplements 21 to 26.

1. An AI monitoring device, comprising:
a receiver configured to receive a signal or information transmitted by a terminal equipment; and
processor circuitry configured to perform monitoring or performance evaluation on an AI/ML model in a network device and/or the terminal equipment according to the signal or information.

2. The device according to claim 1, wherein the network device performs monitoring or performance evaluation on the AI/ML model in the terminal equipment, and the device further comprises:
a transmitter configured to, in a case where the performance of the AI/ML model satisfies a predetermined condition, transmit instruction information for stopping the AI/ML model to the terminal equipment.

3. The device according to claim 2, wherein the signal or information transmitted by the terminal equipment is a signal or information related to the AI/ML model in the terminal equipment for a signal processing function.

4. The device according to claim 2, wherein the instruction information further includes identification information of the AI/ML model, and/or, the instruction information further instructs the terminal equipment to switch to non-AI/ML processing corresponding to a signal processing function,
the identification information of the AI/ML model including at least one of the following: a signal processing function identifier to which the AI/ML model corresponds, an identifier of the AI/ML model, a model group identifier of the AI/ML model, or an intra-group identifier of the AI/ML model.

5. The device according to claim 2, wherein the AI/ML model operates in the terminal equipment and is used for channel state information estimation or prediction, and the network device monitors hybrid automatic retransmission request feedback information from the terminal equipment, and performs performance evaluation on the AI/ML model according to the hybrid automatic retransmission request feedback information.

6. The device according to claim 5, wherein the network device configures and instructs the terminal equipment to perform channel state information estimation and reporting, the terminal equipment performing channel state information estimation or prediction by using the AI/ML model, the network device receives channel state information reported by the terminal equipment, transmits downlink information according to the reported channel state information, and receives the hybrid automatic retransmission request feedback information transmitted by the terminal equipment, wherein the hybrid automatic retransmission request feedback information is generated by the terminal equipment based on the downlink information.

7. The device according to claim 6, wherein the network device receives channel change instruction information transmitted by the terminal equipment, the channel change instruction information including information on a change of a channel between the network device and the terminal equipment in a time domain and/or a frequency domain and/or a space domain, the network device generates measurement resource configuration information and/or report resource configuration information according to the channel change instruction information, and transmits the measurement resource configuration information and/or the report resource configuration information to the terminal equipment.

8. The device according to claim 2, wherein the AI/ML model operates in the terminal equipment and is used for beam management or beam prediction, and the network device monitors an uplink signal from the terminal equipment, and performs performance evaluation on the AI/ML model according to the uplink signal.

9. The device according to claim 8, wherein the network device transmits reference signals corresponding to the number of repeated transmissions of beams or the number of repeated transmissions of channel state information reference signals, the terminal equipment performing beam estimation by using the AI/ML model to obtain beam estimation information, the network device receives the beam estimation information reported by the terminal equipment, and receives uplink signals transmitted by the terminal equipment, wherein the uplink signals are generated by the terminal equipment based on the beam estimation information.

10. The device according to claim 2, wherein the AI/ML model operates in the terminal equipment and is used for beam management or beam prediction, and the network device monitors the hybrid automatic retransmission request feedback information from the terminal equipment, and performs performance evaluation on the AI/ML model according to the hybrid automatic retransmission request feedback information.

11. The device according to claim 10, wherein the network device configures and instructs the terminal equipment to perform beam prediction, the terminal equipment performing beam prediction by using the AI/ML model, the network device receives the beam prediction information reported by the terminal equipment, transmits downlink information according to the reported beam prediction information, and receives the hybrid automatic retransmission request feedback information transmitted by the terminal equipment, wherein the hybrid automatic retransmission request feedback information is generated by the terminal equipment based on the downlink information.

12. The device according to claim 1, wherein the network device performs monitoring or performance evaluation on the AI/ML model in the network device, and in a case where the performance of the AI/ML model satisfies the predetermined condition, the network device stops the AI/ML model.

13. The device according to claim 12, wherein the signal or information transmitted by the terminal equipment includes at least one of the following: a sounding reference signal, reference signal received power, hybrid automatic retransmission request feedback information, beam failure request information, or beam failure recovery information.

14. The device according to claim 1, wherein the network device performs monitoring or performance evaluation on an AI/ML model in a cell, and in a case where the number of terminal equipments with the performance of the AI/ML model satisfying the predetermined condition reaches a threshold, the network device determines to stop the AI/ML model.

15. The device according to claim 14, wherein the network device broadcasts identification information of an AI/ML model in the cell with performance lower than the threshold via system information in the cell, and/or, broadcasts identification information of an AI/ML model in the cell with performance higher than the threshold via system information in the cell.

16. The device according to claim 15, wherein the network device configures cell-specific configuration information for one or more terminal equipments, so that the one or more terminal equipments feed(s) back a signal or information for monitoring an AI/ML model according to the configuration information.

17. The device according to claim 15, wherein the network device transmits identification information of an AI/ML model in the cell with performance lower than the threshold to another cell or a core network device, and/or transmits identification information of an AI/ML model in the cell with performance higher than the threshold to another cell or a core network device.

18. An AI monitoring device, comprising:
a receiver configured to receive a signal or information transmitted by a network device; and
processor circuitry configured to perform monitoring or performance evaluation on an AI/ML model in the network device and/or a terminal equipment according to the signal or information.

19. The device according to claim 18, wherein the terminal equipment performs monitoring or performance evaluation on the AI/ML model in the network device, and in a case where the performance of the AI/ML model satisfies a predetermined condition, the terminal equipment transmits request information for stopping the AI/ML model to the network device;
and/or, the terminal equipment performs monitoring or performance evaluation on the AI/ML model in the terminal equipment, and in a case where the performance of the AI/ML model satisfies the predetermined condition, the terminal equipment transmits request information for stopping the AI/ML model to the network device.

20. A communication system, comprising:
a terminal equipment configured to receive a signal or information transmitted by a network device, and perform monitoring or performance evaluation on an AI/ML model in the network device and/or the terminal equipment according to the signal or information; and/or
the network device configured to receive a signal or information transmitted by the terminal equipment, and perform monitoring or performance evaluation on the AI/ML model in the network device and/or the terminal equipment according to the signal or information.
